(19) United States
(12) Patent Application Publication
(10) Pub. No.: US 2026/0238138 A1
(43) Pub. Date: Aug. 13, 2026

(54) MULTILEVEL INVERTER CONTROL

(71) Applicant: GM Global Technology Operations LLC, Detroit, MI (US)

(72) Inventors: Chandra S. Namuduri, Troy, MI (US); Suresh Gopalakrishnan, Troy, MI (US); Anno Yoo, Rochester, MI (US); Rashmi Prasad, Troy, MI (US); Mohamed Kamel, Birmingham, MI (US)

(21) Appl. No.: 19/049,294

(22) Filed: Feb. 10, 2025

(51) Int. Cl. H02M 7/483; B60L 15/00; B60L 15/20; B60L 50/40; B60L 50/60; H02M 1/00; H02M 1/12

(52) U.S. Cl. CPC H02M 7/483; B60L 15/007; B60L 15/20; B60L 50/60; H02M 1/0048; H02M 1/12; B60L 50/40; B60L 2240/423

(57) ABSTRACT

A power inverter system may include a multilevel inverter, an electric motor in electrical communication with the multilevel inverter, and a controller in electrical communication with the multilevel inverter. The controller is programmed to determine a commanded torque for the electric motor. The controller is further programmed to compare the commanded torque to an upper torque threshold for a three-level mode of the multilevel inverter. The controller is further programmed to produce the commanded torque using the electric motor by operating the multilevel inverter in a two-level mode in response to determining that the commanded torque is greater than the upper torque threshold. The controller is further programmed to produce the commanded torque using the electric motor by operating the multilevel inverter in the three-level mode in response to determining that the commanded torque is less than the upper torque threshold.

### INTRODUCTION

The present disclosure relates to systems and methods for power inversion for electric vehicles.

To manage power in electric vehicle applications, power inverters may be utilized. Power inverters are power-electronic devices typically including semiconductor switches configured to be controllable to accomplish power inversion tasks such as, for example, direct current (DC) to alternating current (AC) conversion. For example, power inverters may be used to convert DC power from a vehicle battery to three-phase AC power to power an electric drive motor. Power inverters may also be used to allow bi-directional power conversion for regenerative braking applications. In some examples, power inverters are realized as a two-level inverters which are capable of synthesizing AC waveforms using pulse-width modulation between two voltage levels. In other examples, power inverters are realized as multilevel inverters which are capable of synthesizing AC waveforms using pulse-width modulation between three or more voltage levels. Multilevel inverters may provide increased efficiency and decreased total harmonic distortion compared to two-level inverters. In electric vehicle applications, increased drive system efficiency is advantageous to increase vehicle performance and range.

While systems and methods for power inverters achieve their intended purpose, there is a need for new and improved systems and methods for power inverters for electric vehicles.

### SUMMARY

According to several aspects, a power inverter system is provided. The system may include a multilevel inverter, an electric motor in electrical communication with the multilevel inverter, and a controller in electrical communication with the multilevel inverter. The controller is programmed to determine a commanded torque for the electric motor. The controller is further programmed to compare the commanded torque to an upper torque threshold for a three-level mode of the multilevel inverter. The controller is further programmed to produce the commanded torque using the electric motor by operating the multilevel inverter in a two-level mode in response to determining that the commanded torque is greater than the upper torque threshold. The controller is further programmed to produce the commanded torque using the electric motor by operating the multilevel inverter in the three-level mode in response to determining that the commanded torque is less than the upper torque threshold.

In another aspect of the present disclosure, the multilevel inverter further may include a direct current (DC) bus and a plurality of capacitors forming a neutral point from the DC bus. The multilevel inverter further may include an alternating current (AC) bus in electrical communication with the electric motor and a plurality of main semiconductor switches in electrical communication with the DC bus and the AC bus. The multilevel inverter further may include a plurality of auxiliary semiconductor switches in electrical communication with the neutral point and the AC bus.

In another aspect of the present disclosure, to produce the commanded torque using the electric motor by operating the multilevel inverter in the two-level mode, the controller is further programmed to operate the plurality of auxiliary semiconductor switches in a non-conducting state in response to determining that the commanded torque is greater than the upper torque threshold.

In another aspect of the present disclosure, the upper torque threshold is determined based at least in part on a typical maximum commanded torque during typical operation of the electric motor. The upper torque threshold is less than a maximum rated torque of the electric motor.

In another aspect of the present disclosure, the upper torque threshold is determined such that at least greater than 50% of all torque commands received during a service life of the electric motor are less than or equal to the upper torque threshold.

In another aspect of the present disclosure, the plurality of auxiliary semiconductor switches are sized based at least in part on the upper torque threshold.

In another aspect of the present disclosure, the plurality of auxiliary semiconductor switches are sized to tolerate a current less than or equal to a maximum current required by the electric motor to produce a torque equal to the upper torque threshold.

In another aspect of the present disclosure, the plurality of auxiliary semiconductor switches further may include one or more monolithic bi-directional semiconductor switches.

In another aspect of the present disclosure, to produce the commanded torque using the electric motor by operating the multilevel inverter in the three-level mode, the controller is further programmed to produce the commanded torque using the electric motor by operating the multilevel inverter in the three-level mode in response to determining that the commanded torque is less than the upper torque threshold and less than a lower torque threshold.

In another aspect of the present disclosure, the lower torque threshold is determined based on the upper torque threshold and a predetermined torque hysteresis offset.

According to several aspects, a method for operating a power inverter system for a vehicle is provided. The method may include determining a commanded torque to be produced by an electric motor of the vehicle. The method may include comparing the commanded torque to an upper torque threshold for a three-level mode of a multilevel inverter of the vehicle. The multilevel inverter is in electrical communication with the electric motor. The method may include producing the commanded torque using the electric motor by operating the multilevel inverter in a two-level mode in response to determining that the commanded torque is greater than the upper torque threshold. The method may include producing the commanded torque using the electric motor by operating the multilevel inverter in the three-level mode in response to determining that the commanded torque is less than the upper torque threshold.

In another aspect of the present disclosure, the method further may include determining the upper torque threshold based at least in part on a typical maximum commanded torque during typical operation of the electric motor. The upper torque threshold is determined such that at least greater than 50% of all torque commands received during a service life of the electric motor are less than or equal to the upper torque threshold. The upper torque threshold is less than a maximum rated torque of the electric motor.

In another aspect of the present disclosure, producing the commanded torque using the electric motor by operating the multilevel inverter in the three-level mode further may include producing the commanded torque using the electric motor by operating the multilevel inverter in the three-level mode in response to determining that the commanded torque is less than the upper torque threshold and less than a lower torque threshold. The lower torque threshold is determined based on the upper torque threshold and a predetermined torque hysteresis offset.

In another aspect of the present disclosure, producing the commanded torque using the electric motor by operating the multilevel inverter in the three-level mode further may include controlling a plurality of main semiconductor switches of the multilevel inverter to transfer energy from a direct current (DC) bus to an alternating current (AC) bus. The AC bus is in electrical communication with the electric motor. Producing the commanded torque using the electric motor by operating the multilevel inverter in the three-level mode further may include controlling a plurality of auxiliary semiconductor switches of the multilevel inverter to transfer energy from the DC bus to the AC bus.

In another aspect of the present disclosure, producing the commanded torque using the electric motor by operating the multilevel inverter in the two-level mode further may include controlling the plurality of main semiconductor switches of the multilevel inverter to transfer energy from the DC bus to the AC bus. Producing the commanded torque using the electric motor by operating the multilevel inverter in the two-level mode further may include controlling the plurality of auxiliary semiconductor switches of the multilevel inverter to be in a non-conducting state.

In another aspect of the present disclosure, one or more component ratings of the plurality of auxiliary semiconductor switches are chosen based at least in part on the upper torque threshold.

In another aspect of the present disclosure, the one or more component ratings of the plurality of auxiliary semiconductor switches are chosen to tolerate a current less than or equal to a maximum current required by the electric motor to produce a torque equal to the upper torque threshold.

According to several aspects, a power inverter system for a vehicle is provided. The power inverter system may include a traction battery and an electric motor. The electric motor is configured to propel the vehicle. The power inverter system further may include a multilevel inverter including a direct current (DC) bus in electrical communication with the traction battery. The multilevel inverter further may include a plurality of capacitors forming a neutral point from the DC bus. The multilevel inverter further may include an alternating current (AC) bus in electrical communication with the electric motor. The multilevel inverter further may include a plurality of main semiconductor switches in electrical communication with the DC bus and the AC bus. The multilevel inverter further may include a plurality of auxiliary semiconductor switches in electrical communication with the neutral point and the AC bus. One or more component ratings of the plurality of auxiliary semiconductor switches are chosen to tolerate a current less than or equal to a maximum current required by the electric motor to produce a torque equal to an upper torque threshold. The power inverter system may include a controller in electrical communication with the multilevel inverter. The controller is programmed to determine a commanded torque for the electric motor. The controller is further programmed to compare the commanded torque to the upper torque threshold. The upper torque threshold is defined as a maximum torque of the electric motor for which the multilevel inverter is operated in a three-level mode. The controller is further programmed to produce the commanded torque using the electric motor by operating the multilevel inverter in a two-level mode in response to determining that the commanded torque is greater than the upper torque threshold. The controller is further programmed to produce the commanded torque to the electric motor by operating the multilevel inverter in the three-level mode in response to determining that the commanded torque is less than the upper torque threshold.

In another aspect of the present disclosure, to operate the multilevel inverter in the three-level mode, the controller is further programmed to control the plurality of main semiconductor switches of the multilevel inverter to transfer energy from the DC bus to the AC bus. To operate the multilevel inverter in the three-level mode, the controller is further programmed to control the plurality of auxiliary semiconductor switches of the multilevel inverter to transfer energy from the DC bus to the AC bus.

In another aspect of the present disclosure, to operate the multilevel inverter in the two-level mode, the controller is further programmed to control the plurality of main semiconductor switches of the multilevel inverter to transfer energy from the DC bus to the AC bus. To operate the multilevel inverter in the two-level mode, the controller is further programmed to control the plurality of auxiliary semiconductor switches of the multilevel inverter to be in a non-conducting state.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a power inverter system, according to an exemplary embodiment;

FIG. 2 is a schematic diagram of a multilevel inverter, according to an exemplary embodiment;

FIG. 3 is a flowchart of a method for operating the power inverter system, according to an exemplary embodiment; and

FIG. 4 is an exemplary torque-speed graph of an electric motor, according to an exemplary embodiment.

### DETAILED DESCRIPTION

The following description is merely exemplary in nature and is not intended to limit the present disclosure, application, or uses.

In aspects of the present disclosure, it is advantageous for power inverter systems to provide a highest possible efficiency. For example, in the context of electric vehicles, high efficiency power conversion can increase vehicle range. Accordingly, multilevel inverters can be utilized to reduce ripple and thus loss, increasing efficiency. However, multilevel inverters have a higher component count than two-level inverters, resulting in increased size, weight, and/or resource use. The present disclosure provides a new and improved system and method for power conversion which capitalizes on the benefits of multilevel inverters while minimizing the effects of any drawbacks.

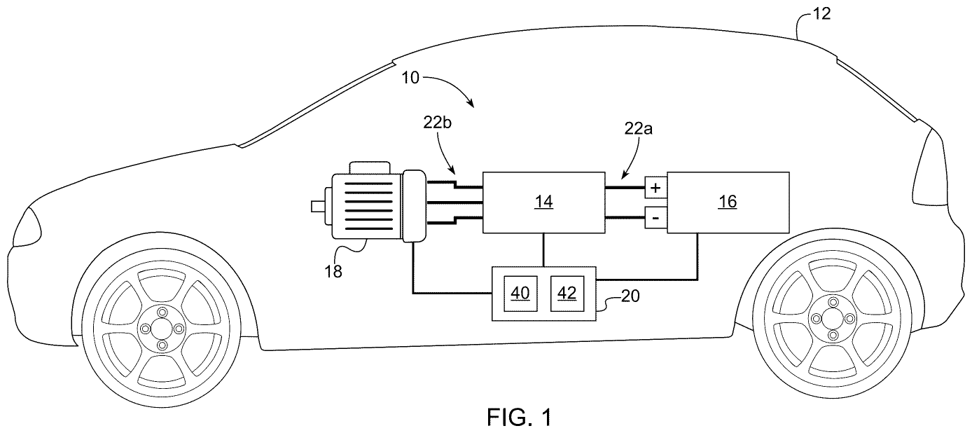

Referring to FIG. 1, a power inverter system is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. Furthermore, it should be understood that the system 10 may also be used in other applications besides vehicle applications. The system 10 generally includes a multilevel inverter 14, a battery 16, an electric motor 18, and a controller 20.

The multilevel inverter 14 is used to transfer energy between the battery 16 and the electric motor 18. In the scope of the present disclosure, a multilevel inverter is a power electronic device used to convert direct current (DC) into alternating current (AC) with multiple voltage levels. Unlike two-level inverters, which produce only two output voltage levels, multilevel inverters generate stepped waveforms with more than two levels output voltage levels.

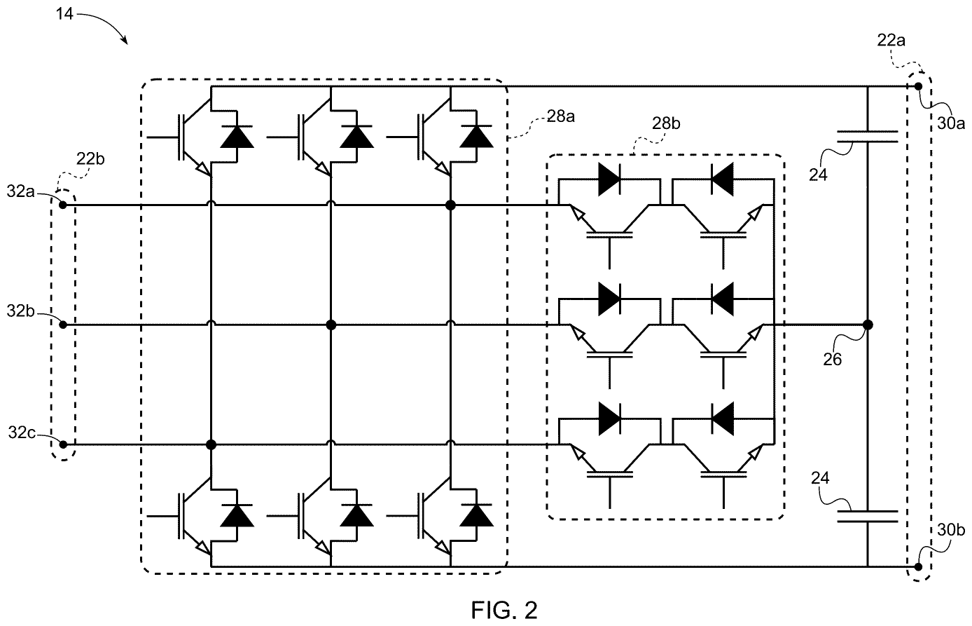

Referring to FIG. 2 a schematic diagram of an exemplary T-type three-level embodiment of the multilevel inverter 14 is shown. Referring to FIG. 2 and with continued reference to FIG. 1, the multilevel inverter 14 includes a DC bus 22a, an AC bus 22b, a plurality of capacitors 24 forming a neutral point 26 from the DC bus 22a, a plurality of main semiconductor switches 28a, and a plurality of auxiliary semiconductor switches 28b. The DC bus 22a provides DC power to the multilevel inverter 14. In a non-limiting example, the DC bus 22a is in electrical communication with the battery 16 via a positive DC port 30a and a negative DC port 30b. The AC bus 22b provides AC power to the electric motor 18. In a non-limiting example, the AC bus 22b is in electrical communication with the electric motor 18 via a first AC phase port 32a, a second AC phase port 32b, and a third AC phase port 32c. The plurality of capacitors 24 are used to form the neutral point 26 between the positive DC port 30a and the negative DC port 30b. In a non-limiting example, the neutral point 26 provides a voltage equal to one half of the voltage across the positive DC port 30a and the negative DC port 30b.

The plurality of main semiconductor switches 28a are in electrical communication with the DC bus 22a and the AC bus 22b and are configured to be controlled by the controller 20 (e.g., via a control terminal such as a gate terminal, a base terminal, and/or the like) to convert DC power from the DC bus 22a to three-phase AC power at the AC bus 22b, providing two voltage levels for each AC phase leg. The plurality of main semiconductor switches 28a may include any type of uni- or bi-directional modular or monolithic semiconductor switches made from any material, including, for example, insulated gate bipolar transistors (IGBTs), metal-oxide-semiconductor field-effect transistors (MOSFETs), gate turn-off thyristors (GTOs), silicon controlled rectifiers (SCRs), MOS-controlled thyristors (MCTs), bipolar junction transistors (BJTs), static induction transistors (SITs), static induction thyristors (SITs), high electron mobility transistors (HEMTs), junction field-effect transistors (JFETs), and/or the like. In an exemplary embodiment, a control terminal (e.g., a gate terminal, a base terminal, and/or the like) of each of the plurality of main semiconductor switches 28a is in electrical communication with the controller 20. In a non-limiting example, the plurality of main semiconductor switches 28a are sized to tolerate a maximum rated current of the electric motor 18.

The plurality of auxiliary semiconductor switches 28b are in electrical communication with the neutral point 26 and the AC bus 22b and are configured to be controlled by the controller 20 (e.g., via a control terminal such as a gate terminal, a base terminal, and/or the like) to convert DC power from the battery 16 to three-phase AC power at the AC bus 22b, providing a third voltage level for each AC phase leg. The plurality of auxiliary semiconductor switches 28b may include any type of bi-directional modular or monolithic semiconductor switches made from any material, including, for example, insulated gate bipolar transistors (IGBTs), metal-oxide-semiconductor field-effect transistors (MOSFETs), gate turn-off thyristors (GTOs), silicon controlled rectifiers (SCRs), MOS-controlled thyristors (MCTs), bipolar junction transistors (BJTs), static induction transistors (SITs), static induction thyristors (SITs), high electron mobility transistors (HEMTs), junction field-effect transistors (JFETs), and/or the like.

In a non-limiting example, the plurality of auxiliary semiconductor switches 28b includes three pairs of anti-series uni-directional switches effectively forming one bi-directional switch for each AC phase leg, as shown in FIG. 2. In another non-limiting example, the plurality of auxiliary semiconductor switches 28b includes three monolithic bi-directional semiconductor switches, one monolithic bi-directional semiconductor switch for each AC phase leg. It should be understood that any circuit using any number of uni-and/or bi-directional switches to realize the plurality of auxiliary semiconductor switches 28b is within the scope of the present disclosure.

In an exemplary embodiment, the plurality of auxiliary semiconductor switches 28b are sized based at least in part on an upper current threshold. In the scope of the present disclosure, the upper current threshold is a maximum current typically supplied by the multilevel inverter 14 to the electric motor 18. In the scope of the present disclosure “typically” can be understood to mean “in a majority of cases” or, in other words “at least greater than 50% of the time”. In a non-limiting example, the upper current threshold is less than the maximum rated current of the electric motor 18.

In a non-limiting example, the upper current threshold is determined based on an upper torque threshold. In the scope of the present disclosure, the upper torque threshold is a typical maximum commanded torque during typical operation of the electric motor 18. In a non-limiting example, the upper torque threshold is determined such that at least greater than 50% of all torque commands received during a service life of the electric motor 18 are less than or equal to the upper torque threshold. In another non-limiting example, the upper torque threshold is determined such that at least greater than 75% of all torque commands received during the service life of the electric motor 18 are less than or equal to the upper torque threshold. In another non-limiting example, the upper torque threshold is determined such that at least greater than 90% of all torque commands received during the service life of the electric motor 18 are less than or equal to the upper torque threshold. In a non-limiting example, the upper torque threshold is less than a maximum rated torque of the electric motor 18. It should be understood that the upper torque threshold may be determined with respect to any proportion of torque commands received during the service life of the electric motor 18.

In an exemplary embodiment, the upper torque threshold is determined by statistical analysis of simulation or measurement of vehicle performance while performing a standardized driving cycle (e.g., the urban dynamometer driving schedule (UDDS), the highway fuel economy driving schedule (HWFET), the worldwide harmonized light vehicles test procedure (WLTP), the new European driving cycle (NEDC), and/or the like). In another exemplary embodiment, the upper torque threshold is determined by statistical analysis of real-world driving data (e.g., crowdsourced data).

The upper current threshold is then determined based on the upper torque threshold using, for example, known current-torque characteristics of the electric motor 18. In an exemplary embodiment, the upper current threshold is equal to a maximum current required by the electric motor 18 to produce a torque equal to the upper torque threshold. In another non-limiting example where the electric motor 18 is replaced by a different type of load, the upper current threshold is determined using statistical analysis of simulation or measurement of current draw of the load during normal use or operation of the load.

In a non-limiting example, one or more component ratings (e.g., continuous current ratings, peak current ratings, on-resistance, temperature ratings, and/or the like) of the plurality of auxiliary semiconductor switches 28b are chosen to tolerate a maximum current equal to the upper current threshold. Therefore, the upper torque threshold may also be understood as a maximum torque of the electric motor 18 for which the multilevel inverter 14 is operated in a mode which utilizes the plurality of auxiliary semiconductor switches 28b (i.e., a three-level mode, as will be discussed in greater detail below).

In a non-limiting example, the plurality of auxiliary semiconductor switches 28b are sized smaller than the plurality of main semiconductor switches 28a. In other words, in a non-limiting example, the one or more component ratings of the plurality of auxiliary semiconductor switches 28b are chosen to tolerate a lower maximum current than the plurality of main semiconductor switches 28a. For example, the plurality of auxiliary semiconductor switches 28b may have a lower continuous current rating than the plurality of main semiconductor switches 28a.

In an exemplary embodiment, the DC bus 22a, the AC bus 22b, the plurality of capacitors 24, the neutral point 26, the plurality of main semiconductor switches 28a, and the plurality of auxiliary semiconductor switches 28b are connected as shown in FIG. 2. It should be understood that the above description of the multilevel inverter 14 is merely exemplary in nature, and that various additional multilevel inverter circuits and topologies are within the scope of the present disclosure.

Referring again to FIG. 1, the battery 16 is used to supply DC power to the multilevel inverter 14. In an exemplary embodiment, the battery 16 is a traction battery of the vehicle 12. It should be understood that the battery 16 may be any source of DC power without departing from the scope of the present disclosure. The battery 16 is in electrical communication with the positive DC port 30a and the negative DC port 30b of the DC bus 22a as discussed above.

The electric motor 18 is used to receive AC power from the multilevel inverter 14. In an exemplary embodiment, the electric motor 18 is an electric motor of the vehicle 12 configured to propel the vehicle 12. In a non-limiting example, the electric motor 18 is a three-phase AC induction motor. It should be understood that other types of AC motors are also within the scope of the present disclosure. It should also be understood that the electric motor 18 may include or be replaced by any AC load without departing from the scope of the present disclosure. The electric motor 18 is in electrical communication with the first AC phase port 32a, the second AC phase port 32b, and the third AC phase port 32c of the AC bus 22b as discussed above.

The controller 20 is used to control the operation of the multilevel inverter 14 and implement a method 100 for operating the system 10, as will be described below. In an exemplary embodiment, the controller 20 is also used to control and/or monitor the operation of the battery 16 and/or the electric motor 18. The controller 20 includes at least one processor 40 and a non-transitory computer readable storage device or media 42. The processor 40 may be a custom made or commercially available processor, a central processing unit (CPU), a graphics processing unit (GPU), an auxiliary processor among several processors associated with the controller 20, a semiconductor-based microprocessor (in the form of a microchip or chip set), a macroprocessor, a combination thereof, or generally a device for executing instructions.

The computer readable storage device or media 42 may include volatile and nonvolatile storage in read-only memory (ROM), random-access memory (RAM), and keep-alive memory (KAM), for example. KAM is a persistent or non-volatile memory that may be used to store various operating variables while the processor 40 is powered down. The computer-readable storage device or media 42 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions.

The controller 20 may also include multiple controllers which are in electrical communication with each other. The controller 20 may be inter-connected with additional systems and/or controllers of the vehicle 12, allowing the controller 20 to access data such as, for example, speed, acceleration, braking, and steering angle of the vehicle 12.

The controller 20 is in electrical communication with the multilevel inverter 14 and, in some embodiments, the battery 16 and/or the electric motor 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 20 are within the scope of the present disclosure. It should further be understood that, in the scope of the present disclosure, electrical communication also includes power and/or energy transfer between electrical devices (e.g., using conducting wires and/or wireless power transmission techniques).

In an exemplary embodiment, the controller 20 is configured to execute program instructions (e.g., stored in the media 42) to operate the multilevel inverter 14. In an exemplary embodiment, the multilevel inverter 14 can operate in a two-level mode or a three-level mode. In the two-level mode, only the plurality of main semiconductor switches 28a is used. In a non-limiting example, in the two-level mode, the plurality of main semiconductor switches 28a are switched by the controller 20 using a space vector modulation (SVM) algorithm and the plurality of auxiliary semiconductor switches 28b are operated in a non-conducting state (i.e., each of the plurality of auxiliary semiconductor switches 28b are placed in an “off” or “open” state where no current is conducted). In the three-level mode, both the plurality of main semiconductor switches 28a and the plurality of auxiliary semiconductor switches 28b are used. In a non-limiting example, in the three-level mode, both the plurality of main semiconductor switches 28a and the plurality of auxiliary semiconductor switches 28b are switched by the controller 20 using a space vector modulation (SVM) algorithm to control current flow in the multilevel inverter 14.

As discussed above, the plurality of auxiliary semiconductor switches 28b are sized based on the upper current threshold (which is related to the upper torque threshold). Therefore, the plurality of auxiliary semiconductor switches 28b should not be operated when the multilevel inverter 14 is supplying currents greater than the upper current threshold. Accordingly, the upper current threshold (and the upper torque threshold) can be understood as an upper threshold for operation of the multilevel inverter 14 in the three-level mode, as will be discussed in greater detail below.

Space vector modulation (SVM) is described in, for example, “Space Vector PWM Scheme for Three Phase Three Level T-type NPC Inverter” by M. Sajitha and R. Ramchand. (2nd International Conference on Intelligent Computing, Instrumentation and Control Technologies (ICICICT), pp. 523-528, Jul. 2019), the entire contents of which is hereby incorporated by reference. It should be understood that the multilevel inverter 14 may be controlled using a closed feed-back loop based on data gathered from sensors on/in the electric motor 18 such as, for example, current sensors, position sensors, rotational velocity sensors, and/or the like. It should also be understood that various additional algorithms and methods for controlling the individual semiconductor switches of the multilevel inverter 14 may be used within the scope of the present disclosure. An exemplary method for determining whether to operate the multilevel inverter 14 in the two-level mode or the three-level mode will be discussed below in reference to the method 100.

Furthermore, the controller 20 may be configured to execute program instructions to monitor and/or control other aspects or features of the vehicle 12, such as, for example, receiving inputs from occupants of the vehicle 12 (e.g., accelerator pedal inputs, brake pedal inputs, steering inputs, and/or the like), generating/providing control outputs for autonomous driving and/or driving assistance features, monitoring status and/or diagnostic information of vehicle components (e.g., the electric motor 18 and/or the battery 16), and/or the like.

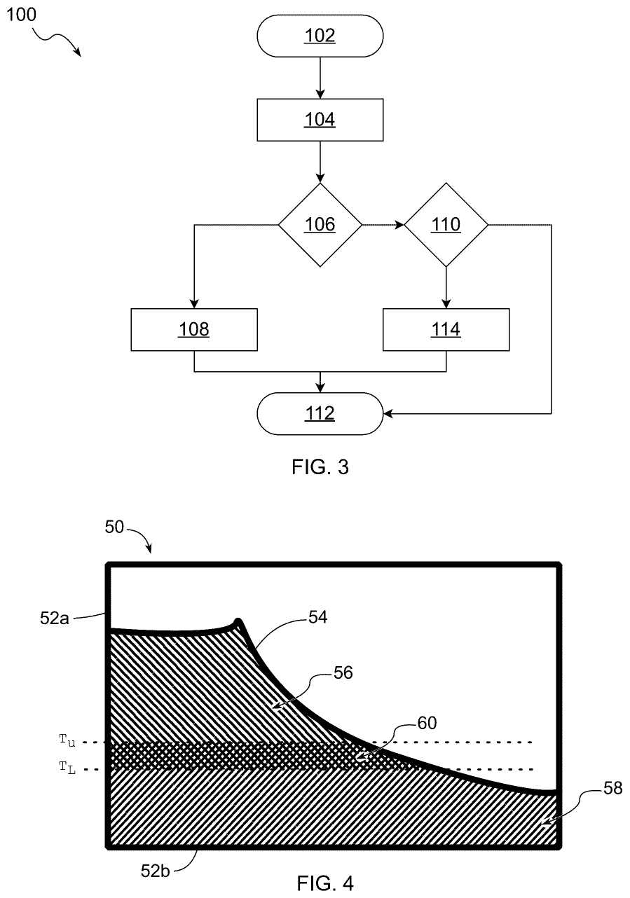

Referring to FIG. 3, a flowchart of the method 100 for operating the system 10 is shown. The method 100 begins at block 102 and proceeds to block 104. At block 104, the controller 20 determines a commanded torque for the electric motor 18. In the scope of the present disclosure, the commanded torque is a torque which should be provided by the electric motor 18. In an exemplary embodiment, the controller 20 determines the commanded torque based at least in part on an input received from an accelerator pedal of the vehicle 12. In another exemplary embodiment, the controller 20 determines the commanded torque based at least in part on a command received from an automated driving and/or driving assistance system of the vehicle 12 or software module of the controller 20. In another exemplary embodiment, the controller 20 determines the commanded torque based on an open-or closed-loop feedback algorithm configured to achieve a desired vehicle speed and/or acceleration in spite of loads caused by vehicle weight, road incline, cargo/towing load, and/or the like. It should be understood that any method for determining the commanded torque, including receiving the commanded torque from an external system or controller, is within the scope of the present disclosure. After block 104, the method 100 proceeds to block 106.

At block 106, the controller 20 compares the commanded torque to the upper torque threshold. The definition and determination of the upper torque threshold is discussed in greater detail above. If the commanded torque determined at block 104 is greater than the upper torque threshold, the method 100 proceeds to block 108. If the commanded torque determined at block 104 is less than or equal to the upper torque threshold, the method 100 proceeds to block 110.

At block 108, the controller 20 operates the multilevel inverter 14 in the two-level mode in response to determining that the commanded torque determined at block 104 is greater than the upper torque threshold. In an exemplary embodiment, to operate the multilevel inverter 14 in the two-level mode, the controller 20 controls the plurality of main semiconductor switches 28a to transfer energy from the DC bus 22a to the AC bus 22b using pulse-width modulation with two voltage levels such that an approximately sinusoidal voltage waveform is produced on each of the first AC phase port 32a, the second AC phase port 32b, and the third AC phase port 32c and controls the plurality of auxiliary semiconductor switches 28b to be in the non-conducting state, as discussed above. After block 108, the method 100 proceeds to enter a standby state at block 112.

At block 110, the controller 20 compares the commanded torque determined at block 104 to a lower torque threshold. In the scope of the present disclosure, the lower torque threshold is used to provide hysteresis to prevent chattering between the two-level mode and the three-level mode of operation. In an exemplary embodiment, the lower torque threshold is determined based at least in part on the upper torque threshold and a predetermined torque hysteresis offset (e.g., five newton-meters). In an exemplary embodiment, the predetermined torque hysteresis offset is determined by statistical analysis of simulation or experimentation. In a non-limiting example, the lower torque threshold is equal to the upper torque threshold minus the predetermined torque hysteresis offset. If the commanded torque determined at block 104 is less than the lower torque threshold, the method 100 proceeds to block 114. If the commanded torque determined at block 104 is greater than or equal to the lower torque threshold, the operating mode of the multilevel inverter 14 is not changed and the method 100 proceeds to enter the standby state at block 112.

At block 114, the controller 20 operates the multilevel inverter 14 in the three-level mode in response to determining that the commanded torque determined at block 104 is less than the lower torque threshold. In an exemplary embodiment, to operate the multilevel inverter 14 in the three-level mode, the controller 20 controls the plurality of main semiconductor switches 28a to transfer energy from the DC bus 22a to the AC bus 22b and controls the plurality of auxiliary semiconductor switches 28b to transfer energy from the DC bus 22a to the AC bus 22b. The plurality of main semiconductor switches 28a and the plurality of auxiliary semiconductor switches 28b are used in tandem to produce a voltage waveform with lower total harmonic distortion on each of the first AC phase port 32a, the second AC phase port 32b, and the third AC phase port 32c using pulse-width modulation with three voltage levels. After block 114, the method 100 proceeds to enter the standby state at block 112.

In an exemplary embodiment, the controller 20 repeatedly exits the standby state 112 and restarts the method 100 at block 102. In a non-limiting example, the controller 20 exits the standby state 112 and restarts the method 100 on a timer, for example, every one hundred microseconds.

Referring to FIG. 4, an exemplary torque-speed graph 50 of the electric motor 18 is shown. The exemplary torque-speed graph 50 includes a torque axis 52a, a rotational speed axis 52b, and an exemplary torque-speed curve 54 of the electric motor 18. Furthermore, an exemplary upper torque threshold is shown with the dashed line labeled TU and an exemplary lower torque threshold is shown with the dashed line labeled TL. The exemplary torque-speed graph 50 illustrates operating envelopes of the multilevel inverter 14 in the two-level mode and the three-level mode. A first shaded region 56 above TU indicates operation in the two-level mode according to the method 100. A second shaded region 58 below TL indicates operation in the three-level mode according to the method 100. A third shaded region 60 between TU and TL indicates a hysteresis region where the multilevel inverter 14 may operate in either the two-level mode or the three-level mode according to the method 100. It should be understood that the exemplary torque-speed graph 50, the exemplary torque-speed curve 54, the value of the exemplary upper torque threshold TU, and the value of the exemplary lower torque threshold TL are merely exemplary in nature and are not necessarily to scale.

The system 10 and method 100 of the present disclosure offer several advantages. By operating the system 10 according to the method 100, the plurality of auxiliary semiconductor switches 28b must only be sized to conduct the upper current threshold, rather than a maximum rated current of the electric motor 18. Therefore, the plurality of auxiliary semiconductor switches 28b may be smaller, resulting in reduced size, reduced weight, and reduced resource use. In conclusion, the system 10 and the method 100 take advantage of the benefits of a three-level inverter (e.g., improved output waveform quality, reduced total harmonic distortion (THD), lower switching losses, and/or the like) during a majority of typical operating points of the electric motor 18 while minimizing drawbacks typically associated with three-level inverters such as larger size, larger weight, and greater resource use.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A power inverter system comprising:
a multilevel inverter;
an electric motor in electrical communication with the multilevel inverter; and
a controller in electrical communication with the multilevel inverter, wherein the controller is programmed to:
determine a commanded torque for the electric motor;
compare the commanded torque to an upper torque threshold for a three-level mode of the multilevel inverter;
produce the commanded torque using the electric motor by operating the multilevel inverter in a two-level mode in response to determining that the commanded torque is greater than the upper torque threshold; and
produce the commanded torque using the electric motor by operating the multilevel inverter in the three-level mode in response to determining that the commanded torque is less than the upper torque threshold.

2. The power inverter system of claim 1, wherein the multilevel inverter further comprises:
a direct current (DC) bus;
a plurality of capacitors forming a neutral point from the DC bus;
an alternating current (AC) bus in electrical communication with the electric motor;
a plurality of main semiconductor switches in electrical communication with the DC bus and the AC bus; and
a plurality of auxiliary semiconductor switches in electrical communication with the neutral point and the AC bus.

3. The power inverter system of claim 2, wherein to produce the commanded torque using the electric motor by operating the multilevel inverter in the two-level mode, the controller is further programmed to:
operate the plurality of auxiliary semiconductor switches in a non-conducting state in response to determining that the commanded torque is greater than the upper torque threshold.

4. The power inverter system of claim 3, wherein the upper torque threshold is determined based at least in part on a typical maximum commanded torque during typical operation of the electric motor, and wherein the upper torque threshold is less than a maximum rated torque of the electric motor.

5. The power inverter system of claim 4, wherein the upper torque threshold is determined such that at least greater than 50% of all torque commands received during a service life of the electric motor are less than or equal to the upper torque threshold.

6. The power inverter system of claim 2, wherein the plurality of auxiliary semiconductor switches are sized based at least in part on the upper torque threshold.

7. The power inverter system of claim 6, wherein the plurality of auxiliary semiconductor switches are sized to tolerate a current less than or equal to a maximum current required by the electric motor to produce a torque equal to the upper torque threshold.

8. The power inverter system of claim 7, wherein the plurality of auxiliary semiconductor switches further comprises:
one or more monolithic bi-directional semiconductor switches.

9. The power inverter system of claim 1, wherein to produce the commanded torque using the electric motor by operating the multilevel inverter in the three-level mode, the controller is further programmed to:
produce the commanded torque using the electric motor by operating the multilevel inverter in the three-level mode in response to determining that the commanded torque is less than the upper torque threshold and less than a lower torque threshold.

10. The power inverter system of claim 9, wherein the lower torque threshold is determined based on the upper torque threshold and a predetermined torque hysteresis offset.

11. A method for operating a power inverter system for a vehicle, the method comprising:
determining a commanded torque to be produced by an electric motor of the vehicle;
comparing the commanded torque to an upper torque threshold for a three-level mode of a multilevel inverter of the vehicle, wherein the multilevel inverter is in electrical communication with the electric motor;
producing the commanded torque using the electric motor by operating the multilevel inverter in a two-level mode in response to determining that the commanded torque is greater than the upper torque threshold; and
producing the commanded torque using the electric motor by operating the multilevel inverter in the three-level mode in response to determining that the commanded torque is less than the upper torque threshold.

12. The method of claim 11, further comprising:
determining the upper torque threshold based at least in part on a typical maximum commanded torque during typical operation of the electric motor, wherein the upper torque threshold is determined such that at least greater than 50% of all torque commands received during a service life of the electric motor are less than or equal to the upper torque threshold, and wherein the upper torque threshold is less than a maximum rated torque of the electric motor.

13. The method of claim 11, producing the commanded torque using the electric motor by operating the multilevel inverter in the three-level mode further comprises:
producing the commanded torque using the electric motor by operating the multilevel inverter in the three-level mode in response to determining that the commanded torque is less than the upper torque threshold and less than a lower torque threshold, wherein the lower torque threshold is determined based on the upper torque threshold and a predetermined torque hysteresis offset.

14. The method of claim 13, wherein producing the commanded torque using the electric motor by operating the multilevel inverter in the three-level mode further comprises:
controlling a plurality of main semiconductor switches of the multilevel inverter to transfer energy from a direct current (DC) bus to an alternating current (AC) bus, wherein the AC bus is in electrical communication with the electric motor; and
controlling a plurality of auxiliary semiconductor switches of the multilevel inverter to transfer energy from the DC bus to the AC bus.

15. The method of claim 14, wherein producing the commanded torque using the electric motor by operating the multilevel inverter in the two-level mode further comprises:
controlling the plurality of main semiconductor switches of the multilevel inverter to transfer energy from the DC bus to the AC bus; and
controlling the plurality of auxiliary semiconductor switches of the multilevel inverter to be in a non-conducting state.

16. The method of claim 15, wherein one or more component ratings of the plurality of auxiliary semiconductor switches are chosen based at least in part on the upper torque threshold.

17. The method of claim 16, wherein the one or more component ratings of the plurality of auxiliary semiconductor switches are chosen to tolerate a current less than or equal to a maximum current required by the electric motor to produce a torque equal to the upper torque threshold.

18. A power inverter system for a vehicle, the power inverter system comprising:
a traction battery;
an electric motor, wherein the electric motor is configured to propel the vehicle;
a multilevel inverter including:
a direct current (DC) bus in electrical communication with the traction battery;
a plurality of capacitors forming a neutral point from the DC bus;
an alternating current (AC) bus in electrical communication with the electric motor;
a plurality of main semiconductor switches in electrical communication with the DC bus and the AC bus; and
a plurality of auxiliary semiconductor switches in electrical communication with the neutral point and the AC bus, wherein one or more component ratings of the plurality of auxiliary semiconductor switches are chosen to tolerate a current less than or equal to a maximum current required by the electric motor to produce a torque equal to an upper torque threshold;
a controller in electrical communication with the multilevel inverter, wherein the controller is programmed to:
determine a commanded torque for the electric motor;
compare the commanded torque to the upper torque threshold, wherein the upper torque threshold is defined as a maximum torque of the electric motor for which the multilevel inverter is operated in a three-level mode;
produce the commanded torque using the electric motor by operating the multilevel inverter in a two-level mode in response to determining that the commanded torque is greater than the upper torque threshold; and
produce the commanded torque to the electric motor by operating the multilevel inverter in the three-level mode in response to determining that the commanded torque is less than the upper torque threshold.

19. The power inverter system of claim 18, to operate the multilevel inverter in the three-level mode, the controller is further programmed to:
control the plurality of main semiconductor switches of the multilevel inverter to transfer energy from the DC bus to the AC bus; and
control the plurality of auxiliary semiconductor switches of the multilevel inverter to transfer energy from the DC bus to the AC bus.

20. The power inverter system of claim 19, wherein to operate the multilevel inverter in the two-level mode, the controller is further programmed to:
control the plurality of main semiconductor switches of the multilevel inverter to transfer energy from the DC bus to the AC bus; and
control the plurality of auxiliary semiconductor switches of the multilevel inverter to be in a non-conducting state.
